(19) United States
(12) Patent Application Publication
(10) Pub. No.: US 2026/0191628 A1
(43) Pub. Date: Jul. 9, 2026

(54) DENTURE CLEANING TOOL AND METHOD OF CLEANING A DENTURE

(71) Applicant: James Parisien, Odanah, WI (US)

(72) Inventor: James Parisien, Odanah, WI (US)

(21) Appl. No.: 19/014,945

(22) Filed: Jan. 9, 2025

(51) Int. Cl. A61C 17/00; B08B 1/10; B08B 1/30

(52) U.S. Cl. CPC A61C 17/036; B08B 1/10; B08B 1/30; B08B 2240/00

(57) ABSTRACT

A denture cleaning tool includes a body portion and a tip portion attached to the body portion. The body portion includes a top body surface, a bottom body surface, and lateral body surfaces connecting the top body surface and the bottom body surface. The body portion includes a melamine foam at the top body surface, the bottom body surface, and the lateral body surfaces. The tip portion includes a top tip surface, a bottom tip surface, and a lateral tip surface connecting the top tip surface and the bottom tip surface. The tip portion includes a melamine foam at the top tip surface, the bottom tip surface, and the lateral tip surface.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to denture cleaning devices and more particularly pertains to a new denture cleaning tool for efficient removal of stains and material from the surfaces of the teeth of a denture, both on the exposed surfaces and in between adjacent teeth. The denture cleaning tool has a shape and size suitable for dentures and includes a melamine foam.

### (2) Description of Related Art Including Information Disclosed Under 37 CFR 1.97 and 1.98

The prior art relates to denture cleaning devices and materials. The prior art, as best understood, does not disclose a dental cleaning device that includes melamine foam.

### (H) BRIEF SUMMARY OF THE INVENTION

An embodiment of the disclosure meets the needs presented above in a denture cleaning tool generally comprising a body portion and a tip portion attached to the body portion. The body portion includes a top body surface, a bottom body surface, and lateral body surfaces connecting the top body surface and the bottom body surface. The body portion includes a melamine foam at the top body surface, the bottom body surface, and the lateral body surfaces. The tip portion includes a top tip surface, a bottom tip surface, and a lateral tip surface connecting the top tip surface and the bottom tip surface. The tip portion includes a melamine foam at the top tip surface, the bottom tip surface, and the lateral tip surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a denture cleaning tool according to an embodiment of the disclosure.

FIG. 2 is a perspective view of a first alternative embodiment of the disclosure.

FIG. 3 is a perspective view of a second alternative embodiment of the disclosure.

FIG. 4 is a side view of the second alternative embodiment of the disclosure in use.

FIG. 5 is a front view of the first alternative embodiment of the disclosure in use.

### (J) DETAILED DESCRIPTION OF THE INVENTION

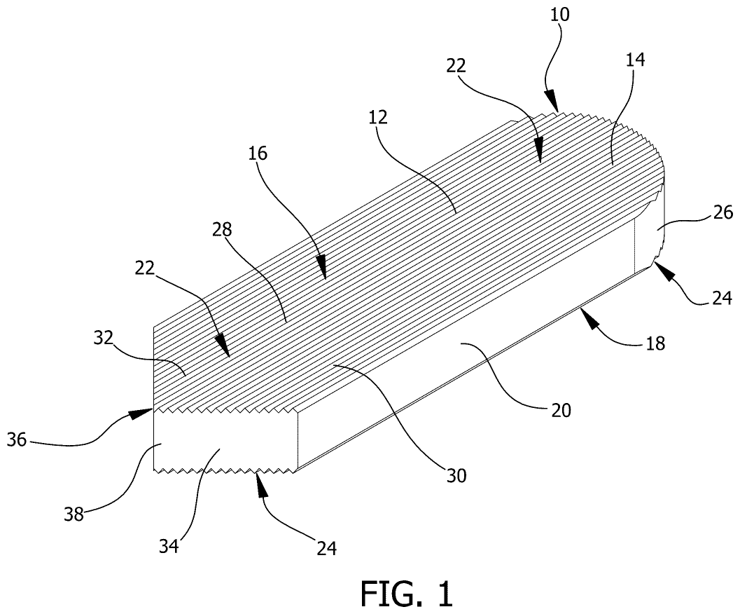

With reference now to the drawings, and in particular to FIGS. 1 through 5 thereof, a new denture cleaning tool embodying the principles and concepts of an embodiment of the disclosure and generally designated by the reference numeral 10 will be described.

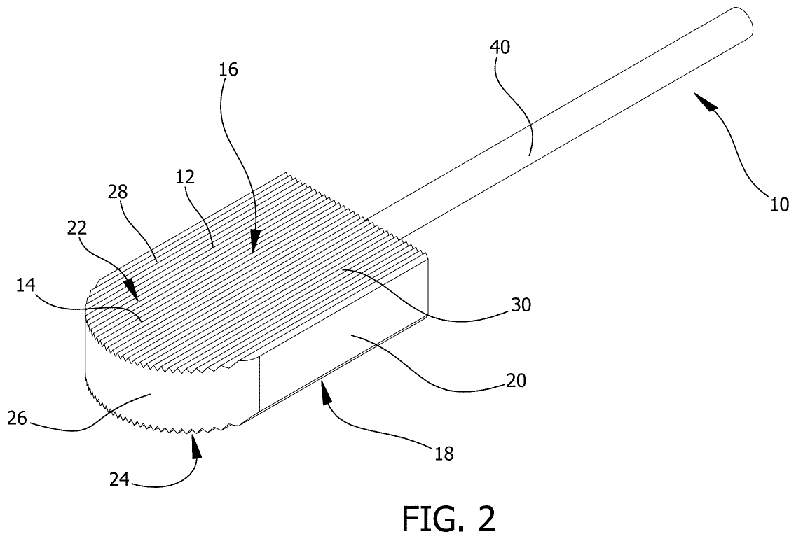

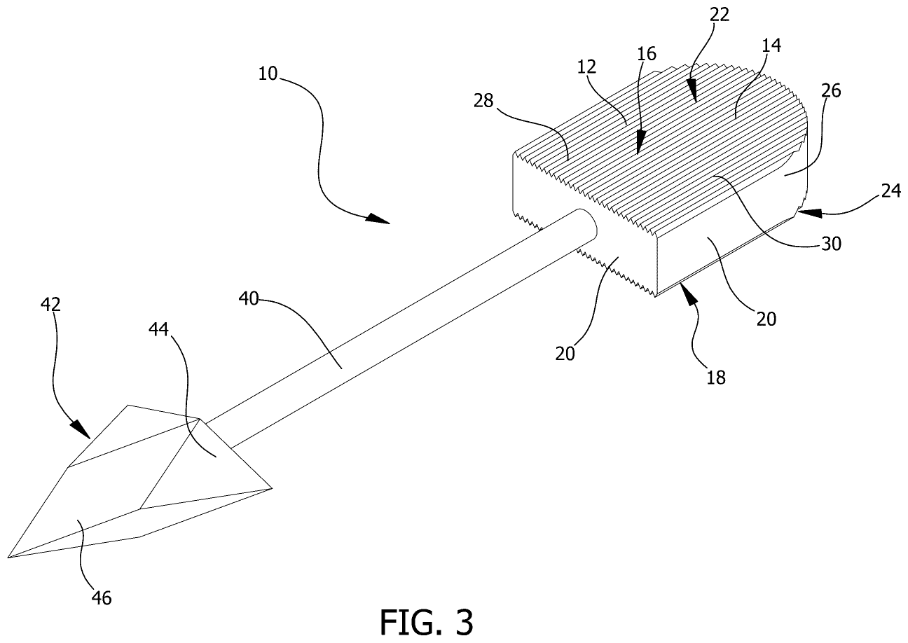

It should first be noted that FIG. 1 shows an exemplary embodiment of the denture cleaning tool 10, and FIGS. 2 and 3 show a first alternative embodiment and a second alternative embodiment, respectively. Components common to all three embodiments use the same reference numerals.

As best illustrated in FIGS. 1 through 5, the denture cleaning tool 10 generally comprises a body portion 12 and a tip portion 14 attached to the body portion 12. The body portion 12 includes a top body surface 16, a bottom body surface 18, and lateral body surfaces 20 connecting the top body surface 16 and the bottom body surface 18. The body portion 12 includes a melamine foam at the top body surface 16, the bottom body surface 18, and the lateral body surfaces 20. The tip portion 14 includes a top tip surface 22, a bottom tip surface 24, and a lateral tip surface 26 connecting the top tip surface 22 and the bottom tip surface 24. The tip portion 14 includes a melamine foam at the top tip surface 22, the bottom tip surface 24, and the lateral tip surface 26. It should be understood that the melamine foam could be an outer layer mounted on an inner structure of a different material, or the entirety of the body portion 12 or the tip portion 14 could consist of melamine foam.

In each of the exemplary embodiments, the lateral tip surface 26 is a continuous curve. However, other shapes, such as angular or rectangular, are within the scope of the disclosure. Each of the top tip surface 22 and the bottom tip surface 24 includes a plurality of projections 28 and a plurality of indentations 30. The projections 28 and the indentations 30 of the tip portion 14 are arranged in an alternating manner to form ridges in parallel alignment. In another possible embodiment, only one of the top tip surface 22 and the bottom tip surface 24 has the projections 28 and the indentations 30. In another possible embodiment, the projections 28 and indentations 30 could be another shape, such as round bumps or wavy grooves. In addition, each of the top body surface 16 and the bottom body surface 18 includes a plurality of projections 28 and a plurality of indentations 30. The projections 28 and the indentations 30 of the body portion 12 are arranged in an alternating manner to form ridges in parallel alignment. The top tip surface 22 is continuous with the top body surface 16. The bottom tip surface 24 is continuous with the bottom body surface 18. The projections 28 and the indentations 30 of the body portion 12 merge with the projections 28 and the indentations 30 of the tip portion 14. This design can be varied as desired to have different surface types to achieve different cleaning effects. For example, in one possible embodiment, the tip portion 14 may have the projections 28 and the indentations 30, whereas the body portion 12 may be smooth, or vice versa.

With reference to FIG. 1, the tip portion 14 is a first tip portion 14, and the denture cleaning tool 10 further includes a second tip portion 32. The second tip portion 32 includes a top tip surface 22, a bottom tip surface 24, and a lateral tip surface 26 connecting the top tip surface 22 and the bottom tip surface 24 of the second tip portion 32. The second tip portion 32 includes a melamine foam at the top tip surface 22, the bottom tip surface 24, and the lateral tip surface 26 of the second tip portion 32. The first tip portion 14 and the second tip portion 32 are positioned at opposite ends of the body portion 12.

Unlike the lateral tip surface 26 of the first tip portion 14, which is a continuous curve, the lateral tip surface 26 of the second tip portion 32 is divided into a first lateral tip surface portion 34 and a second lateral tip surface portion 36 positioned at an acute angle to the first lateral tip surface portion 34 to form a point 38.

Each of the top tip surface 22 and the bottom tip surface 24 of the second tip portion 32 includes a plurality of projections 28 and a plurality of indentations 30. The top tip surface 22 of the second tip portion 32 is continuous with the top body surface 16. The bottom tip surface 24 of the second tip portion 32 is continuous with the bottom body surface 18. The projections 28 and the indentations 30 of the body portion 12 merge with the projections 28 and the indentations 30 the second tip portion 32.

With reference to FIGS. 2 and 3, the denture cleaning tool 10 in the first alternative embodiment and the second alternative embodiment further includes a handle 40 coupled to the body portion 12 and projecting away from the tip portion 14. However, in the second alternative embodiment, the denture cleaning also includes a pick 42 coupled to a first end of the handle 40, wherein the body portion 12 is coupled to a second end of the handle 40.

The pick 42 includes a base pick portion 44 and a pointed pick portion 46, wherein the base pick portion 44 tapers to the pointed pick portion 46. The pointed pick portion 46 includes a melamine foam. In one possible embodiment, the pick 42 is a traditional pick made of plastic.

The denture cleaning tool 10 is sized for use with teeth. Accordingly, the denture cleaning tool 10, in at least one possible embodiment, has a length of less than 80 mm, a width of less than 20 mm, and a thickness of less than 10 mm. Other sizes are within the scope of the disclosure.

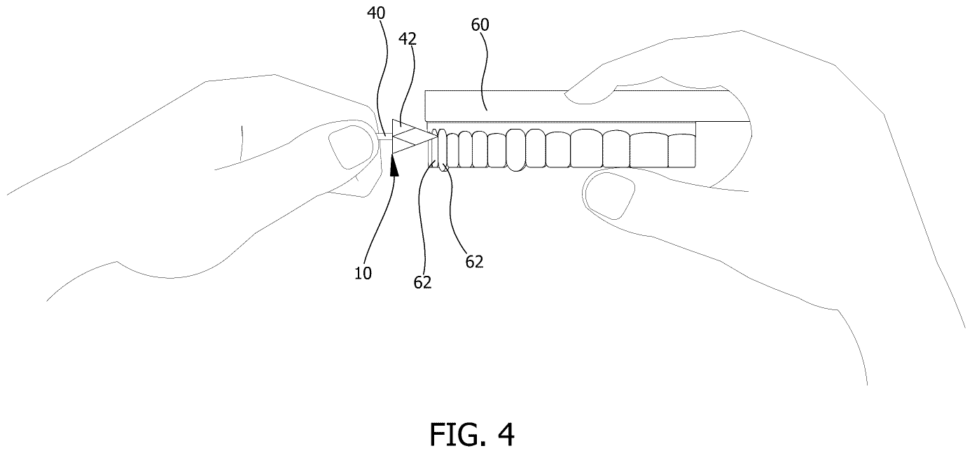

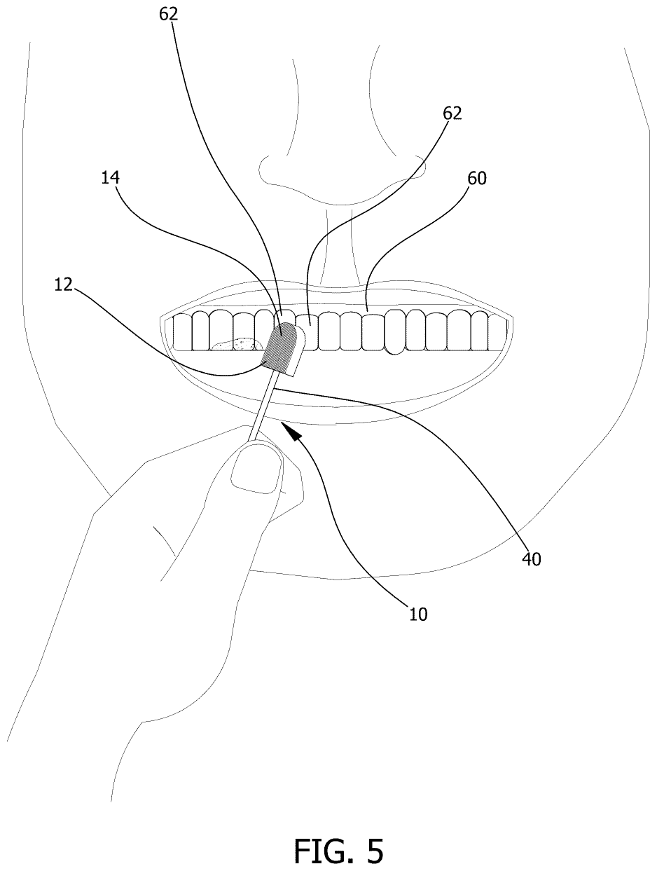

FIGS. 4 and 5 show how to use the denture cleaning tool 10 to clean a denture 60. In general, the user selectively rubs one of the top body surface 16, the bottom body surface 18, the lateral body surfaces 20, the top tip surface 22, the bottom tip surface 24, and the lateral tip surface 26 against a tooth 62 of the denture 60 and thereby removes material from the tooth 62. This action can remove stain-causing material and sticky material, for example. The user can repeatedly selectively rub using either the same or a different one of the top body surface 16, the bottom body surface 18, the lateral body surfaces 20, the top tip surface 22, the bottom tip surface 24 against the tooth or a different tooth 62 of the denture 60 and thereby removing additional material from the tooth 62 or a different tooth 62. The user keeps repeating this process until all material is sufficiently removed from the denture 60. As shown in FIG. 4, the pick 42 can be used to clean in between teeth 62. Similarly, the second tip portion 32, which has the point 38, can also be used to clean in between teeth 62. FIG. 5 shows how the tip portion 14 with the curved lateral tip surface 26 can be used. Essentially any section of the denture cleaning tool 10 can be used to clean the teeth 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A denture cleaning tool comprising:
a body portion including a top body surface, a bottom body surface, and lateral body surfaces connecting said top body surface and said bottom body surface, said body portion including a melamine foam at said top body surface, said bottom body surface, and said lateral body surfaces; and
a tip portion attached to said body portion, said tip portion including a top tip surface, a bottom tip surface, and a lateral tip surface connecting said top tip surface and said bottom tip surface, said tip portion including a melamine foam at said top tip surface, said bottom tip surface, and said lateral tip surface.

2. The denture cleaning tool of claim 1, wherein said lateral tip surface is a continuous curve.

3. The denture cleaning tool of claim 1, wherein said lateral tip surface is divided into a first lateral tip surface portion and a second lateral tip surface portion positioned at an acute angle to said first lateral tip surface portion to form a point.

4. The denture cleaning tool of claim 1, wherein each of said top tip surface and said bottom tip surface includes a plurality of projections and a plurality of indentations.

5. The denture cleaning tool of claim 4, wherein said projections and said indentations of said tip portion are arranged in an alternating manner to form ridges in parallel alignment.

6. The denture cleaning tool of claim 1, wherein each of said top body surface and said bottom body surface includes a plurality of projections and a plurality of indentations.

7. The denture cleaning tool of claim 6, wherein said projections and said indentations of said body portion in an alternating manner to form ridges in parallel alignment.

8. The denture cleaning tool of claim 1, wherein:
each of said top tip surface and said bottom tip surface includes a plurality of projections and a plurality of indentations; and
each of said top body surface and said bottom body surface includes a plurality of projections and a plurality of indentations.

9. The denture cleaning tool of claim 8, wherein:
said top tip surface is continuous with said top body surface;
said bottom tip surface is continuous with said bottom body surface; and
said projections and said indentations of said body portion merge with said projections and said indentations of said tip portion.

10. The denture cleaning tool of claim 1, wherein:
said tip portion is a first tip portion;
the denture cleaning tool further comprises a second tip portion;
said second tip portion includes a top tip surface, a bottom tip surface, and a lateral tip surface connecting said top tip surface and said bottom tip surface of said second tip portion, said second tip portion includes a melamine foam at said top tip surface, said bottom tip surface, and said lateral tip surface of said second tip portion; and
said first tip portion and said second tip portion are positioned at opposite ends of said body portion.

11. The denture cleaning tool of claim 10, wherein:
said lateral tip surface of said first tip portion is a continuous curve; and
said lateral tip surface of said second tip portion is divided into a first lateral tip surface portion and a second lateral tip surface portion positioned at an acute angle to said first lateral tip surface portion to form a point.

12. The denture cleaning tool of claim 11, wherein:
each of said top tip surface and said bottom tip surface of each of said first tip portion and said second tip portion includes a plurality of projections and a plurality of indentations;
each of said top body surface and said bottom body surface includes a plurality of projections and a plurality of indentations;
said top tip surface of each of said first tip portion and said second tip portion is continuous with said top body surface;
said bottom tip surface of each of said first tip portion and said second tip portion is continuous with said bottom body surface; and
said projections and said indentations of said body portion merge with said projections and said indentations of each of said first tip portion and said second tip portion.

13. The denture cleaning tool of claim 1, further including a handle coupled to said body portion and projecting away from said tip portion.

14. The denture cleaning tool of claim 13, wherein:
each of said top tip surface and said bottom tip surface includes a plurality of projections and a plurality of indentations;
each of said top body surface and said bottom body surface includes a plurality of projections and a plurality of indentations;
said top tip surface is continuous with said top body surface;
said bottom tip surface is continuous with said bottom body surface; and
said projections and said indentations of said body portion merge with said projections and said indentations of said tip portion.

15. The denture cleaning tool of claim 14, wherein said lateral tip surface is a continuous curve.

16. The denture cleaning tool of claim 13, further including a pick coupled to a first end of said handle, wherein said body portion is coupled to a second end of said handle.

17. The denture cleaning tool of claim 16, wherein:
said pick includes a base pick portion and a pointed pick portion, wherein said base pick portion tapers to said pointed pick portion; and
said pointed pick portion includes a melamine foam.

18. The denture cleaning tool of claim 17, wherein:
each of said top tip surface and said bottom tip surface includes a plurality of projections and a plurality of indentations;
each of said top body surface and said bottom body surface includes a plurality of projections and a plurality of indentations;
said top tip surface is continuous with said top body surface;
said bottom tip surface is continuous with said bottom body surface;
said projections and said indentations of said body portion merge with said projections and said indentations of said tip portion; and
said lateral tip surface is a continuous curve.

19. The denture cleaning tool of claim 17, wherein said denture cleaning tool has a length of less than 80 mm, a width of less than 20 mm, and a thickness of less than 10 mm.

20. A method of cleaning a denture, said method comprising the steps of:
providing a denture cleaning tool comprising:
a body portion including a top body surface, a bottom body surface, and lateral body surfaces connecting said top body surface and said bottom body surface, said body portion including a melamine foam at said top body surface, said bottom body surface, and said lateral body surfaces; and
a tip portion attached to said body portion, said tip portion including a top tip surface, a bottom tip surface, and a lateral tip surface connecting said top tip surface and said bottom tip surface, said tip portion including a melamine foam at said top tip surface, said bottom tip surface, and said lateral tip surface;
selectively rubbing one of said top body surface, said bottom body surface, said lateral body surfaces, said top tip surface, said bottom tip surface, and said lateral tip surface against a tooth of a denture and thereby removing material from said tooth;
repeating said step of selectively rubbing using either the same or a different one of said top body surface, said bottom body surface, said lateral body surfaces, said top tip surface, said bottom tip surface against said tooth or a different tooth of said denture and thereby removing additional material from said tooth or a different tooth; and
repeating said step of selectively rubbing until all material is sufficiently removed from said denture.
